(19) United States
(12) Patent Application Publication
(10) Pub. No.: US 2012/0266729 A1
(43) Pub. Date: Oct. 25, 2012

(54) Method and System for Processing Stacks of Sheets into Bundles of Securities, in Particular Banknote Bundles

(75) Inventors: Matthias Gygi, Schmitten (CH); Hartmut Karl Sauer, Himmelstadt (DE)

(73) Assignee: KBA-NOTASYS SA, Lausanne 22 (CH)

(21) Appl. No.: 13/384,089

(22) PCT Filed: Aug. 2, 2010
(86) PCT No.: PCT/IB10/53496

§ 371 Date: Apr. 5, 2012

(30) Foreign Application Priority Data
Aug. 3, 2009 (EP) 09167085.1

(51) Int. Cl. B26D 7/06

(52) U.S. Cl. 83/13; 83/703

(57) ABSTRACT

There is described a method for processing stacks of sheets (SS) into bundles (5) of securities, in particular banknote bundles, the method comprising the steps of cutting successive stacks of sheets (SS), each carrying an array of multiple security prints arranged in a matrix of rows and columns, into successive sets of bundle strips (S; S*), and cutting the successive set of bundle strips (S; S*) into successive sets (2) of consecutive bundles (5) of securities. This method further comprises the step of counting the number of substrates within each bundle strip (S; S*) prior to cutting thereof into the successive sets (2) of consecutive bundles (5). Such counting comprises taking at least one image (I) of a at least a portion of a longitudinal side (10) of the bundle strip (S; S*) while the bundle strip (S; S*) is being displaced along a direction of displacement (A) which is parallel to the longitudinal side (10) of the bundle strips (S; S*), and processing the said at least one image (I) to derive a substrate count of the substrates within the bundle strip (S; S*). Also described in a system for carrying out this method.

### TECHNICAL FIELD

The present invention generally relates to the production of securities, in particular banknotes, and more particularly to a method and system for processing stacks of sheets into bundles of securities, in particular banknote bundles.

In the context of the present invention, the term “securities” is to be understood as encompassing all kinds of security documents and/or valuable documents, such as banknotes, cheques, duty stamps, lottery tickets, passports, identification or travel documents, and the like. Preferably, the securities are banknotes.

### PRIOR ART AND BACKGROUND OF THE INVENTION

Methods and apparatuses for processing sheets of securities, especially banknotes, into bundles of securities and stacks of bundles of securities (so-called “finishing” methods and apparatuses) are already known in the art.

Such finishing methods and apparatuses are for instance disclosed in U.S. Pat. No. U.S. Pat. No. 3,939,621, U.S. Pat. No. 4,045,944, U.S. Pat. No. 4,283,902, U.S. Pat. No. 4,453,707, U.S. Pat. No. 4,463,677, U.S. Pat. No. 4,558,557, U.S. Pat. No. 4,558,615, U.S. Pat. No. 4,653,399, European patent application No. EP 0 656 309 A1, International application No. WO 01/49464 A1, European patent application No. EP 1 607 355 A1, and International application No. WO 2008/010125 A2, all in the name of the present Applicant. A particularly advantageous solution is disclosed in International application No. WO 2004/016433 A1 also in the name of the present Applicant, which solution is incorporated herein by reference in its entirety and is particularly suitable for the production of an uninterrupted flow of securities with a consecutive numbering sequence. Other known solutions are disclosed in European patent application No. EP 0 598 679 A1, International application No. WO 2005/018945 A1, International application No. WO 2006/131839 A2 and British patent application No. GB 2 262 729 A.

As explained in the above-identified publications, it is common practice in the art to produce securities in the form of sheets or successive portions of a continuous web each carrying a plurality of security prints arranged in a matrix of rows and columns, which sheets or successive portions of web are ultimately cut to form individual securities, usually after numbering of each security prints.

The term “sheet” will be understood in the following as referring equally to an individual sheet as used in sheet-fed printing presses or to a portion of a continuous web as used in web-fed printing presses, which portion of continuous web is ultimately cut into sheets after the last web printing operation. At the start of the finishing process, a predetermined number of consecutive sheets (typically hundred sheets) are commonly stacked one above the other to form consecutive stacks of sheets, which sheet stacks are then processed one after the other so as to be cut row-wise and column-wise between the security prints to produce individual bundles of securities. These bundles are then usually stacked to form bundle stacks, typically of ten bundles each.

FIG. 1 schematically illustrates a top view of a sheet stack processing system, generally designated by reference numeral 1, for processing stacks of sheets into individual bundles, which system operates in a manner similar to what is disclosed in U.S. Pat. No. 4,283,902 (see also U.S. Pat. No. 4,453,707, U.S. Pat. No. 4,463,677, U.S. Pat. No. 4,558,557, U.S. Pat. No. 4,558,615, and U.S. Pat. No. 4,653,399). This processing system is adapted to process sheets at a typical rate of 10'000 sheets per hour. Reference SS designates in this example a given stack of sheets, typically comprising hundred consecutive sheets stacked one upon the other. As already mentioned, it shall be understood that each sheet carries an array or matrix of security prints printed thereon, which array will be defined as consisting of M columns and N rows. The actual number of columns and rows of security prints on the sheets obviously depends on the sheet dimensions and on the dimensions of each security print.

Within the scope of the present invention, and for the sake of clarity, the term “column” should be understood as referring to the arrangement of security prints one next to the other along a first dimension of the sheets, hereinafter referred to as the “sheet length”, while the term “row” should be understood as referring to the arrangement of security prints one next to the other along the other dimension of the sheets, hereinafter referred to as the “sheet width”, as schematically illustrated in FIG. 2. Strictly speaking, the terms “column”/“row” and “sheet width”/“sheet length” are however interchangeable. According to the above definition, the sheet length typically corresponds to the dimension of the sheets (or web portions) parallel to a transport direction of the sheets (or of the continuous web) through the printing press or presses that were used to carry out the printing operations, while the sheet width corresponds to the dimension of the sheets transversely to the transport direction of the sheets (or of the continuous web). The sheet width is typically greater than the sheet length.

As is typical in the art, the dimensions (whether of individual sheets processed on sheet-fed printing presses or of successive web portions of a continuous web processed on web-fed printing presses) may for instance be as much as 820 mm in width per 700 mm in length (i.e. 820×700 mm). With such sheet dimensions, six (M=6) columns per ten (N =10) rows of security prints with dimensions of e.g. 130×65 mm might for instance be provided on the sheets. With sheet dimensions of 740×680 mm, four (M=4) columns per seven (N=7) rows of security prints with dimensions of e.g. 180×90 mm might for instance be provided on the sheets. For small sheet dimensions, e.g. of 420×400 mm, four (M=4) columns per six (N=6) rows of security prints with dimensions of e.g. 100×60 mm might for instance be provided on the sheets. The above examples are of course given for the purpose of illustration only.

In the schematic illustration of FIG. 1, each sheet carries five (M=5) columns per ten (N=10) rows of security prints, i.e. fifty security prints per sheet. The sheet stack SS is first fed stepwise (along direction y in FIG. 1) through a first cutting station CS1 where the stack SS is cut along the rows of security prints so as to output successive sets of bundle strips S of securities. In this example, ten (N=10) such bundle strips S of securities are produced as a result of the row-wise cutting of each stack SS, each bundle strip S of securities encompassing a given number of security prints, namely five hundred (i.e. M=5 times hundred) security prints in this case (i.e. the equivalent of five bundles of hundred securities each). In the process, margins (not illustrated) at the front and trailing edges of the sheets are typically cut and discarded as well.

Each bundle strip S of securities is then typically fed in sequence through a banding station BS comprising multiple banding units distributed along the length of each bundle strip S of securities (i.e. along direction×in FIG. 1) to provide a securing band B around a corresponding one of the plural positions on the bundle strip S which carry security prints. Suitable banding units for carrying out banding (also referred to as “banderoling”) are for instance disclosed in International application No. WO 2005/085070 A1 in the name of the present Applicant. In this example, the banding station BS comprises as many banding units as there are columns of security prints on each sheet, namely five (M=5) banding units in this example. The banding operation may be omitted or replaced by any other operation aimed at securing the securities together in the form of a bundle arrangement, such as by stapling.

Each bundle strip S of securities thus provided with securing bands B, hereinafter referred to as a banded bundle strip S* of securities, is then fed out of the banding station BS to the subsequent processing station. In the illustrated example, each banded bundle strip S* of securities is fed laterally (along a direction A opposite to direction x in FIG. 1) out of the banding station BS and then (along direction y) to a collating position where all banded bundle strips S* of securities of a given and same sheet stack SS are regrouped to form a stack-like formation SS* of N banded bundle strips S* of securities corresponding to the arrangement of the original sheet stack SS. In the stack-like formation SS*, the banded bundle strips S* are typically located close to one another or even abutting against each other.

The thus assembled stack-like formation SS* of banded bundle strips S* of securities is then fed stepwise (along direction x) through a second cutting station CS2 where the stack-like formation SS* is cut along the columns of security prints so as to output successive sets 2 of bundles 5 of securities, all banded bundle strips S* being cut simultaneously and stepwise by the second cutting station CS2. In this example, five (M=5) successive sets 2 of bundles 5 of securities, each provided with a securing band, are produced as a result of the column-wise cutting of each stack-like formation SS*, each successive set 2 consisting of a given number of bundles 5 of securities disposed next to the other, namely ten (N=10) bundles 5 of hundred individual securities each (i.e. the equivalent of one column of security prints of the original sheet stack SS). In the process, margins (not illustrated) at the right and left edges of the sheets (i.e. margins at the top and bottom of stack-like formation SS* in FIG. 1) are typically cut and discarded as well. Alternatively, as disclosed in U.S. Pat. No. 4,283,902, the right and left margins might be cut prior to feeding of the sheet stack SS to the first cutting station CS1 using additional cutting devices.

Each set 2 of bundles 5 of securities then needs to be evacuated before the next set 2 of bundles 5 arrives. Each bundle 5 of the set 2 must further be separated so as to form a flow a spaced-apart bundles 5, as schematically illustrated in FIG. 1. Such separation is necessary so that each bundle can be further processed individually, especially to form suitable stacks 75 of bundles 2 (referred to hereinafter as “bundle stacks”). This additional processing of the individual bundles 5 into bundle stacks 75 in particular includes the rotation by 180 degrees of every two bundle 5 (which alternate rotation of bundles is schematically illustrated in FIG. 1) so as to compensate for the typical thickness variations of the securities due, for instance, to the varying reliefs created as a result of intaglio printing, the presence of security elements applied onto selected regions of the substrate (such as OVD's—Optically Variable Devices) or of security element embedded locally in the substrate (such as watermarks, security threads, windows, etc.). In that respect, the securing band provided around each bundle is also typically applied at banding station BS in an offset manner with respect to the middle portion of each bundle. A suitable method and system for carrying out the bundle separation and packing operation is for instance disclosed in European Application No. 08155236.6 entitled “METHOD AND SYSTEM FOR PROCESSING BUNDLES OF SECURITIES, IN PARTICULAR BANKNOTE BUNDLES” filed on Apr. 25, 2008 in the name of the present Applicant, now published as EP 2 112 110 A1 (see also International application No. PCT/IB2009/051583 filed on Apr. 16, 2009 which claims priority of the above-mentioned European Application No. 08155236.6, now published as WO 2009/130638 A1).

Considering a typical processing speed of 10'000 sheets per hour, a new stack SS of hundred sheets will be supplied upstream of the first cutting station CS1 every thirty-six seconds (=(100*3'600)/10'000), which amounts to a new bundle strip S, S*, downstream of the first cutting station CS1, every 36/N seconds. In this example where each sheet carries five (M=5) columns and ten (N=10) rows of security prints, this means that a new bundle strip S, S* arrives every 3.6 seconds.

In the context of the above-described finishing methodology, it is important to ensure that the resulting bundles 5 that are ultimately produced each comprise the desired number of substrates, namely hundred substrates, not more, not less. For this reason, a counting operation is typically carried out during finishing so as to check that each bundle 5 contains the proper number of substrates.

Counting can be carried out by mechanical means, such as counting discs, as for instance disclosed in European patent application No. EP 0 737 936 A1. Alternatively, “touchless” optical counting solutions have been proposed, which optical counting solutions make use of optical systems to take an image of a side of a stack of substrates and derive a substrate count therefrom. Such solutions are for instance disclosed in International applications Nos. WO 96/22553 A1, WO 2004/059585 A1, WO 2004/097732 A1 and WO 2006/016234 A1.

According to International application No. WO 2006/016234 A1, optical counting is performed immediately after a cutting operation while the stacked substrates are static under the cutting means and, preferably, while the stacked substrates are still being compressed by compression means at the cutting station. It has been found however that this solution may not be very practical in practice as this leads to limitations in the way the image sensor used to take the image of the side of the stacked substrates can be located and may lead to inaccuracies in the measured image. Indeed, as illustrated in the Figures of International application No. WO 2006/016234 A1, the image sensor needs to be located at the downstream side of the cutting station so as to look at the freshly cut side of the stack of substrates which is still under the cutting means, which implies that the image sensor cannot be located right in front of the stack of substrates (as it would otherwise obstruct the path of the substrates being outputted from the cutting station) but at an angle with respect to the path of the substrates. Furthermore, the time available to take one or more images of the side of the stack of substrates while this stack of substrate is still under the cutting means at the cutting station is limited.

There is therefore a need for an improved solution where optical counting can be carried out with greater freedom and greater robustness without interfering with the finishing process.

### SUMMARY OF THE INVENTION

An aim of the present invention is thus to provide an improved method and system for processing stacks of sheets into bundles of securities, in particular banknote bundles, where the number of substrates can suitably be checked by optical means.

Another aim of the present invention is to provide such a method and system that is simple to implement and robust, while guaranteeing that high production efficiency can be maintained.

Accordingly, the present invention relates to a method for processing stacks of sheets into bundles of securities, in particular banknote bundles, the method comprising the steps of:
cutting successive stacks of sheets, each carrying an array of multiple security prints arranged in a matrix of rows and columns, into successive sets of bundle strips ; and
cutting the successive set of bundle strips into successive sets of consecutive bundles of securities,
wherein the method further comprises the step of counting the number of substrates within each bundle strip prior to cutting thereof into the successive sets of consecutive bundles, the counting comprising:
taking at least one image of a at least a portion of a longitudinal side of the bundle strip while the bundle strip is being displaced along a direction of displacement which is parallel to the longitudinal side of the bundle strips; and
processing the said at least one image to derive a substrate count of the substrates within the bundle strip.

The present invention also relates to a system for processing stacks of sheets into bundles of securities, in particular banknote bundles, the system comprising:
a first cutting station for cutting successive stacks of sheets, each carrying an array of multiple security prints arranged in a matrix of rows and columns, into successive sets of bundle strips; and
a second station for cutting the successive set of bundle strips into successive sets of consecutive bundles of securities,
wherein the system further comprises an optical system for counting the number of substrates within each bundle strip prior to cutting thereof into the successive sets of consecutive bundles, which optical system comprises:
an image sensor for taking at least one image of a at least a portion of a longitudinal side of the bundle strip, which image sensor is placed along a direction of displacement of the bundle strips which is parallel to the longitudinal side of the bundle strip; and
a processing unit for processing the said at least one image to derive a substrate count of the substrates within the bundle strip.

Advantageous embodiments of the present invention form the subject-matter of the appended dependent claims.

According to one embodiment, each bundle strip is provided with a plurality of securing bands distributed along a length of each bundle strip and counting of the number of substrates is carried out on the resulting banded bundle strips. This favours a proper counting operation as the stacked substrates within the bundle strip are secured together thanks to the securing bands.

According to a preferred variant of this embodiment, images of the longitudinal side of each banded bundle strip can advantageously be taken to further check for the proper presence of the securing bands along the length of the banded bundle strips.

According to another embodiment, counting of the number of substrates is preferably carried out several times along the longitudinal side of each bundle strip, for instance at least as many time as there are bundle positions in the bundle strip.

### BRIEF DESCRIPTION OF THE DRAWINGS

The system of the present invention is now illustrated by way of examples with reference to the appended illustrations, in which:

FIG. 1 is a schematic top view of a system for processing stacks of sheets each carrying an array of multiple security prints arranged in a matrix of rows and columns into successive sets of consecutive bundles;

FIG. 2 is a schematic view of a sheet layout illustrating the notions of “columns”, “rows”, “sheet length” and “sheet width” within the scope of the present invention;

FIGS. 3 and 4 are schematic partial perspective views of the system according to one embodiment of the invention;

FIG. 5 is a schematic top view of the system of FIGS. 3 and 4;

FIG. 6 is a an enlarged view of FIG. 5;

FIG. 7 is an illustrative live image taken from a portion of the longitudinal side of a bundle strip; and

FIG. 8 is a schematic block diagram of the optical system used in the context of the invention.

### DETAILED DESCRIPTION OF THE PREFERRED EMBODIMENTS

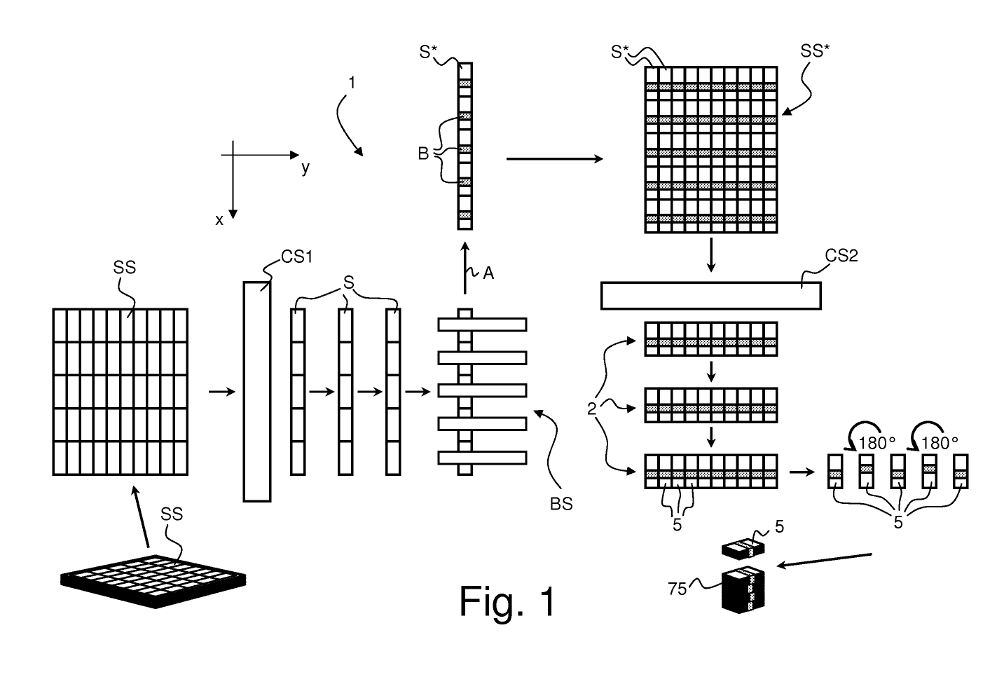

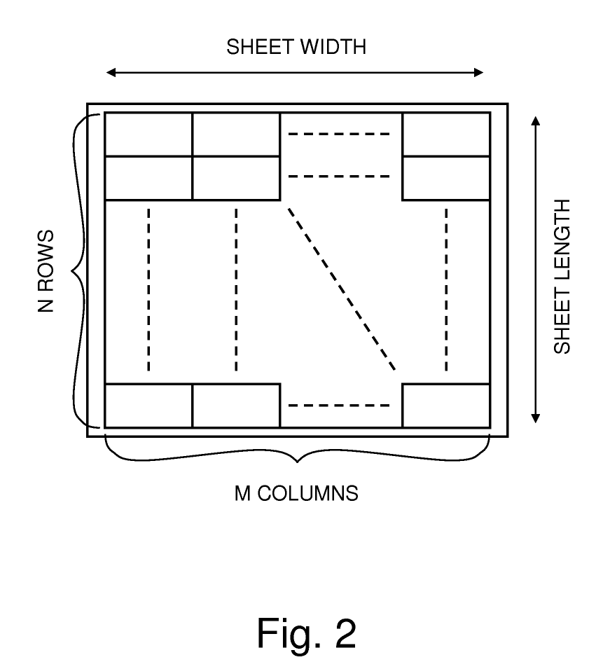

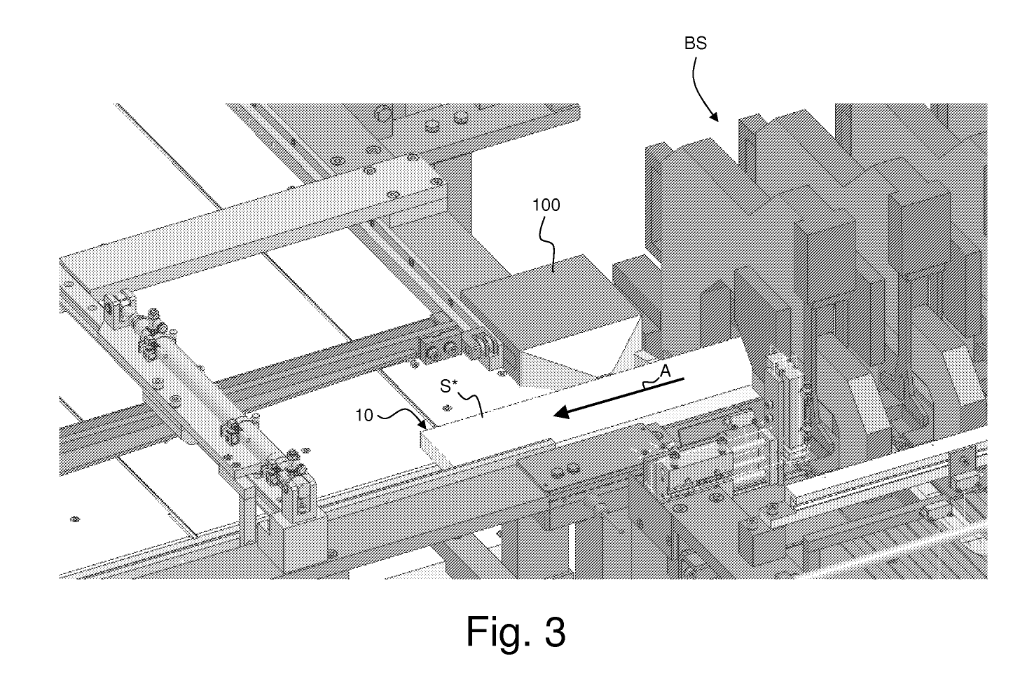

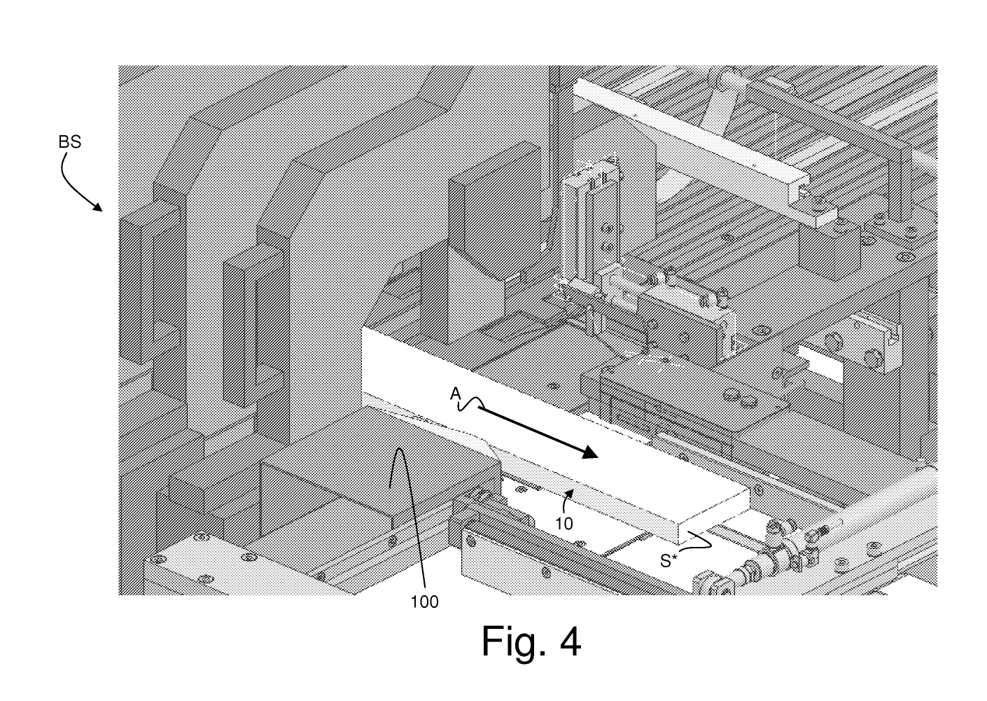

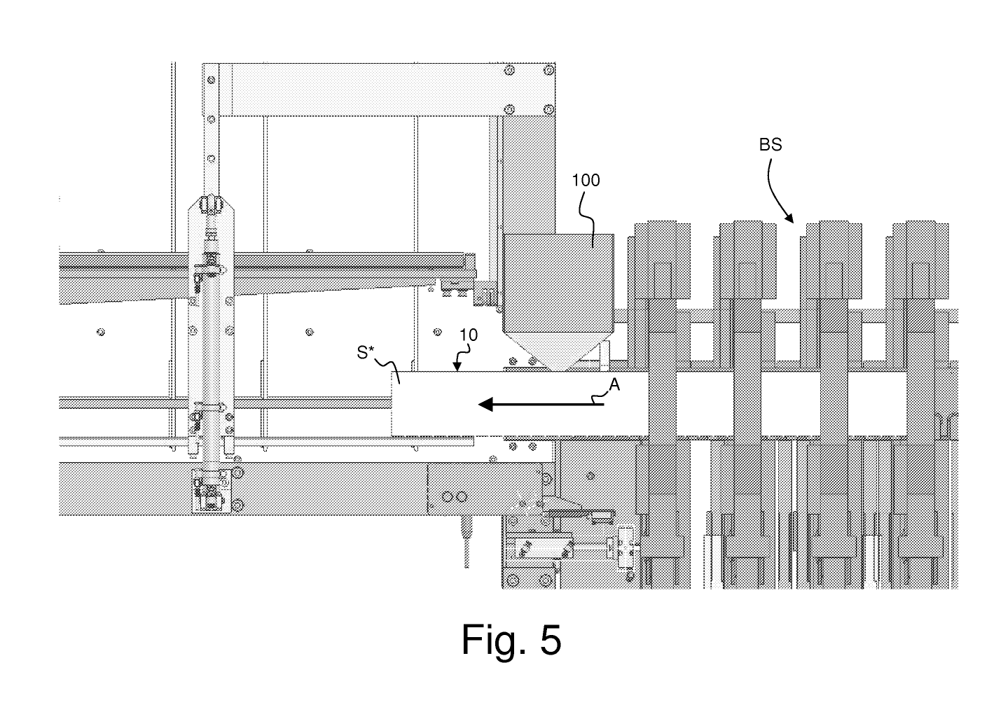

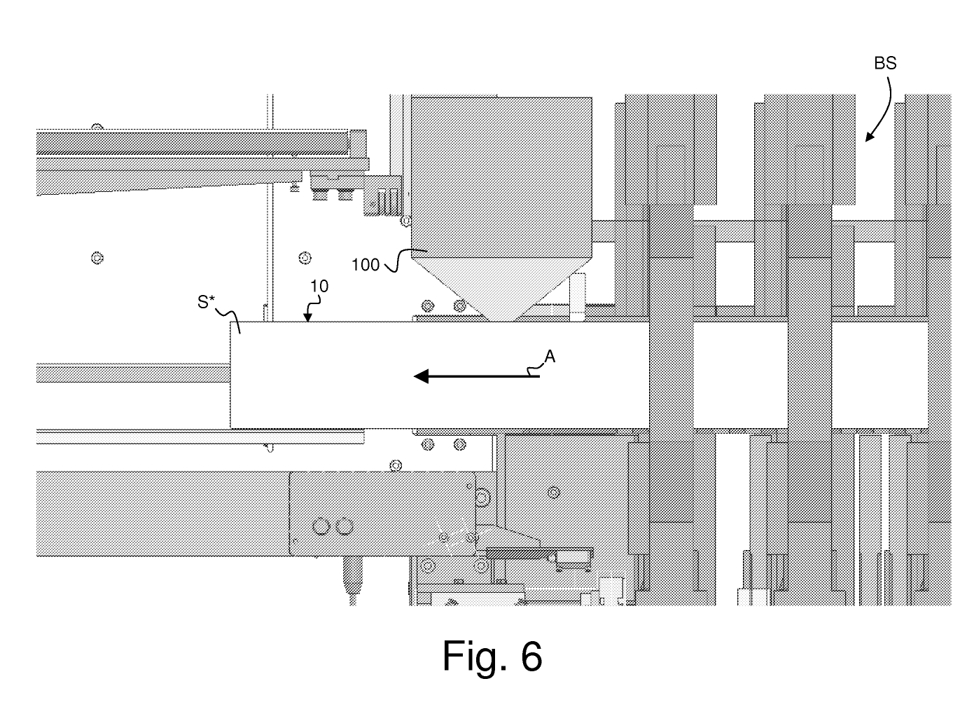

FIGS. 3 to 6 and 8 illustrate an embodiment of the method and system for processing stacks of sheets into bundles of securities, in particular banknote bundles, according to the present invention. FIGS. 3 to 6 are only partial schematic views illustrating how optical counting is carried out in the context of this method and system. As far as the finishing principle is concerned, such finishing principle is similar to the one explained in the preamble hereof in reference to FIGS. 1 and 2, and this finishing principle will accordingly not be explained again.

It suffices to understand that the finishing method generally comprises the steps of (see again FIG. 1):
cutting successive stacks of sheets SS, each carrying an array of multiple security prints arranged in a matrix of rows and columns (see FIG. 2), into successive sets of bundle strips S, S*; and
cutting the successive set of bundle strips S, S* into successive sets 2 of consecutive bundles 5 of securities.

Similarly, it suffices to understand that the finishing system generally comprises (see again FIG. 1):
a first cutting station CS1 for cutting the successive stacks of sheets SS into successive sets of bundle strips S, S*; and
a second station CS2 for cutting the successive set of bundle strips S, S* into successive sets 2 of consecutive bundles 5 of securities.

According to the preferred embodiment illustrated in FIGS. 3 to 6 and 8, optical counting of the number of substrates is carried out downstream of the banding station BS on the banded bundle strips S*. This banding operation is optional and the optical counting operation may therefore alternatively be carried out on non-banded bundle strips S and the below description of the invention is equally applicable in this case. It is however preferred to carried out the optical counting operation on the banded bundle strips S* as this ensures that all substrates within the banded bundle strips S* are properly secured together.

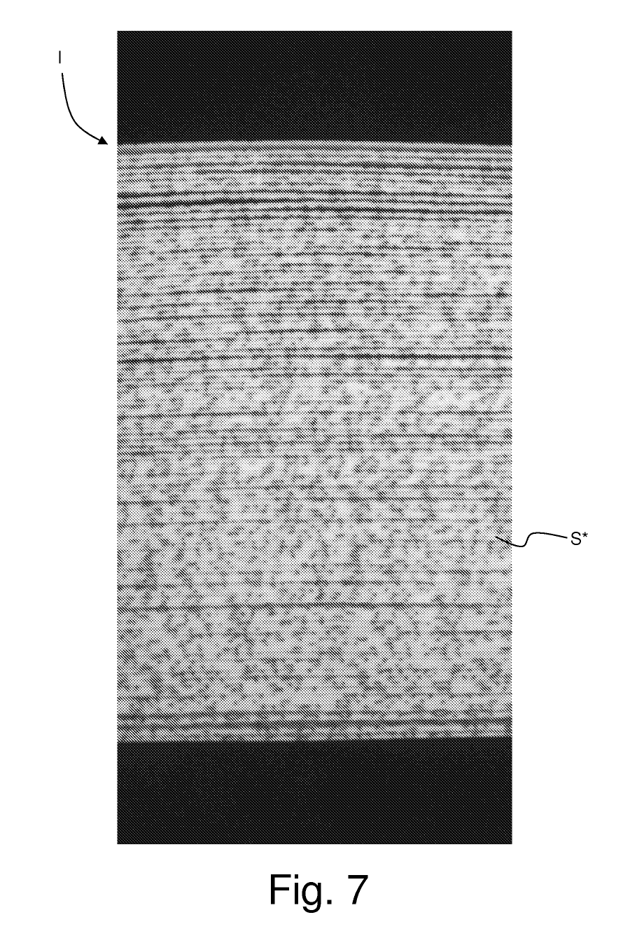

More precisely, as illustrated in FIGS. 3 to 6 and 8, the optical system comprises an image sensor 100 placed along the path of the bundle strips S* for taking at least one image I of a at least a portion of a longitudinal side 10 of the bundle strip S*. An illustrative image I of a portion of the longitudinal side 10 of the bundle strip S* is shown in FIG. 7.

This means that, in the example of FIGS. 3 to 6, at least one image I is taken while the bundle strip S* is being displaced along a direction of displacement A (out of the banding station BS—see FIG. 1) which direction is parallel, in the illustration of FIG. 1, to a direction along which the stacks of sheets SS are cut into the bundle strips S, S* at the first cutting station CS1.

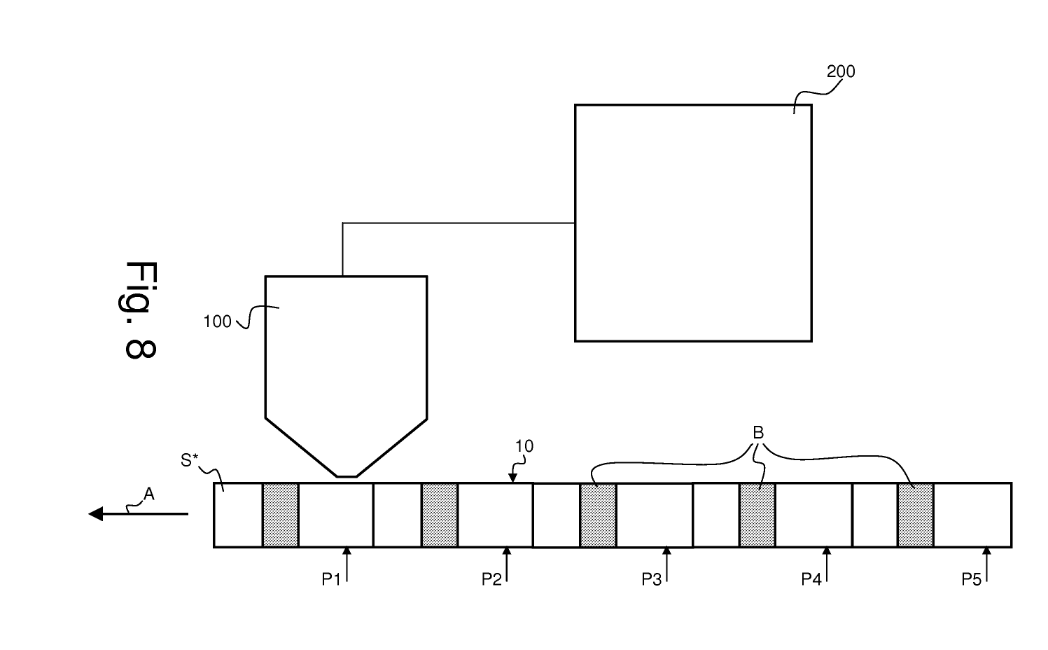

The image senor 100 is coupled to a processing unit 200 (not shown in FIGS. 3 to 6, but schematically illustrated in the block diagram of FIG. 8), which processing unit 200 is designed to process the at least one image I taken by the image sensor 100 to derive therefrom a substrate count of the substrates within the bundle strip S*. Any processing methodology can be applied. In this respect, reference can for instance be made to International application No. WO 2004/097732 A1. The invention is however not limited to this particular processing methodology and any other image processing technique can be used as long as it is suitable to derive a substrate count from the image I taken by the image sensor 100.

Preferably, the processing unit 200 is designed to compare whether the substrate count corresponds to an expected number of substrates (e.g. hundred substrates) and to issue a warning or error signal if the substrate count does not correspond to the expected number of substrates.

The image sensor 100 can comprise a linear sensor for scanning the desired portion of the longitudinal side 10 of the bundle strip S* while the bundle strip S* is moving before the image sensor 100. Alternatively, the image sensor 100 can comprise a array sensor for taking a snapshot of the portion of the longitudinal side 10 of the bundle strip S*. In any case, the image sensor 100 should be suitably designed to output an image I of a desired portion of the longitudinal side 10 of the bundle strip S. Obviously, in the present case where optical counting is carried out on banded bundle strips S*, the image I shall be take at a portion of the longitudinal side 10 of the bundle strip S* which bears no securing band B.

Preferably, a plurality of images I are taken at various portions of the longitudinal side 10 of the bundle strip S*. In this case where the bundle strip S* includes five (M=5) bundle positions, and therefore five securing bands B (see FIGS. 1 and 8), at least five (or possibly six, or more) images are taken along the length of the bundle strip S*, namely between each successive pair of securing bands B (positions P1 to P4 in FIG. 8) and at one extremity of the bundle strip S* (position P5 in FIG. 8).

Advantageously, in the context of the preferred embodiment where the optical counting operation is carried out on the banded bundle strip S*, the optical system 100, 200 can further be used to check for the proper presence of the securing bands B along the length of the banded bundle strip S*. In the present case, this necessitates that the image sensor 100 takes five additional images at the locations along the length of the banded bundle strip S* where the securing bands B are expected. Based on these images, it can then be checked whether a securing band B is located at the corresponding location and a warning or error signal can be generated if this is not the case.

Various modifications and/or improvements of the above-described embodiment might be carried out without departing from the scope of the appended claims. For instance, as already mentioned, the banding operation is optional and the optical counting operation can accordingly be carried out on the non-banded bundle strips S directly.

1. A method for processing stacks of sheets into bundles of securities, in particular banknote bundles, the method comprising the steps of:
cutting successive stacks of sheets, each carrying an array of multiple security prints arranged in a matrix of rows and columns, into successive sets of bundle strips;
cutting the successive set of bundle strips into successive sets of consecutive bundles of securities,
wherein the method further comprises the step of counting the number of substrates within each bundle strip prior to cutting thereof into the successive sets of consecutive bundles, the counting comprising:
taking at least one image of a at least a portion of a longitudinal side of the bundle strip while the bundle strip is being displaced along a direction of displacement which is parallel to the longitudinal side of the bundle strips; and
processing the at least one image to derive a substrate count of the substrates within the bundle strip.

2. The method according to claim 1, wherein each bundle strip is provided with a plurality of securing bands distributed along a length of each bundle strip and wherein counting of the number of substrates is carried out on the resulting banded bundle strips.

3. The method according to claim 2, further comprising the step of taking images of the longitudinal side of each banded bundle strip to check for the proper presence of the securing bands along the length of the banded bundle strips.

4. The method according to claim 1, wherein counting of the number of substrates is carried out several times along the longitudinal side of each bundle strip.

5. The method according to claim 1, further comprising the step of comparing whether the substrate count corresponds to an expected number of substrates and issuing a warning or error signal if the substrate count does not correspond to the expected number of substrates.

6. A system for processing stacks of sheets into bundles of securities, in particular banknote bundles, the system comprising:
a first cutting station for cutting successive stacks of sheets, each carrying an array of multiple security prints arranged in a matrix of rows and columns, into successive sets of bundle strips; and
a second station for cutting the successive set of bundle strips into successive sets of consecutive bundles of securities,
wherein the system further comprises an optical system for counting the number of substrates within each bundle strip prior to cutting thereof into the successive sets of consecutive bundles, which optical system comprises:
an image sensor for taking at least one image of a at least a portion of a longitudinal side of the bundle strip, which image sensor is placed along a direction of displacement of the bundle strips which is parallel to the longitudinal side of the bundle strip; and
a processing unit for processing the at least one image to derive a substrate count of the substrates within the bundle strip.

7. The system according to claim 6, further comprising a banding station with multiple banding units distributed along a length of the bundle strips for providing a plurality of securing bands along the length of each bundle strip and wherein the image sensor is located downstream of the banding station so that counting of the number of substrates is carried out on the resulting banded bundle strips.

8. The system according to claim 7, wherein the optical system further checks for the proper presence of the securing bands along the length of the banded bundle strips.

9. The system according to claim 6, wherein the optical system is designed to take and process several images at various portions of the longitudinal side of the bundle strip.

10. The system according to claim 6, wherein the image sensor comprises a linear sensor for scanning the at least portion of the longitudinal side of the bundle strip while the bundle strip is moving.

11. The system according to claim 6, wherein the image sensor comprises a array sensor for taking a snapshot of the at least portion of the longitudinal side of the bundle strip.
